(19) United States
(12) Patent Application Publication
(10) Pub. No.: US 2025/0115068 A1
(43) Pub. Date: Apr. 10, 2025

(54) FLAGS WITH MOVEABLE INDICATORS

(71) Applicant: Hewlett-Packard Development Company, L.P., Spring, TX (US)

(72) Inventors: Aiqiang Yang, Singapore (SG); Wee Hien Tok, Singapore (SG); Jumariah Binte Jalil, Singapore (SG); Wee Boon Choo, Singapore (SG)

(21) Appl. No.: 18/836,421

(22) PCT Filed: Feb. 9, 2022
(86) PCT No.: PCT/US2022/015746

§ 371 Date: Aug. 7, 2024

(51) Int. Cl. B41J 29/42; B41J 13/10

(52) U.S. Cl. CPC B41J 29/42; B41J 13/106

(57) ABSTRACT

In some examples, the disclosure describes a device that includes a flag, a transfer device to transfer rotational motion of the flag to linear motion of a moveable indicator, and a scanner device to capture an image of a current location of the moveable indicator on a scanner surface.

### BACKGROUND

A printing device can deposit a print substance on to print media to generate images on the print media. In some examples, the printing device utilizes a media tray to receive print media. The print media within the media tray can be picked by a pick roller and provided to a print zone to allow the printing device to deposit the print substance on to the print media to generate an image on the print media.

### BRIEF DESCRIPTION OF THE DRAWINGS

FIG. 1 illustrates an example device that utilizes a flag with a moveable indicator.

FIG. 2 illustrates an example device that utilizes a flag with a moveable indicator.

FIG. 3 illustrates a top-down perspective view of an example device that utilizes a flag with a moveable indicator and a size adjustor mechanism.

FIG. 4 illustrates an example device that utilizes a flag with a convex side and a concave side.

FIG. 5 illustrates an example device that utilizes a flag with a convex side and a concave side.

FIG. 6 illustrates an example system that utilizes a flag with a moveable indicator.

### DETAILED DESCRIPTION

A printing device can receive digital data from a computing device to be utilized to generate physical representations of the digital data on a substrate. A printing device includes a device that can deposit a print substance on to a substrate or print media to generate an image on the substrate. A substrate can include a material that can receive a print substance to generate a permanent or semi-permanent image on the material (e.g., paper, plastic, metal, etc.). In some examples, the printing device can include an inkjet printing device that can deposit an ink substance on a substrate to generate an image on the substrate.

Printing devices can utilize a print media tray or media tray to store print media that can be provided to the print zone such that the print substance can be deposited on the print media. In some examples, devices and/or sensors are utilized to determine a size of the print media within the print media tray. For example, a size adjustor mechanism can be positioned within the print media tray to identify a particular width and/or length of the print media. In these examples, the size adjustor mechanism can be adjusted to the size of the print media within the print media tray and a corresponding sensor can send a signal to the printing device that indicates the size of the print media within the print media tray.

The print media tray can include a mechanism and/or sensors that can be utilized to determine a quantity or relative quantity of print media within the print media tray at a particular time. The mechanism and/or sensors utilized to determine the quantity or relative quantity of the print media can allow the printing device to generate notifications when the print media within the print media tray is running low. In other examples, the printing device may utilize print media from a different print media tray when the quantity of print media within a particular print media tray is below a threshold quantity of print media.

The mechanisms and/or sensors for determining the size of the print media may work with the mechanisms and/or sensors for determining the quantity of print media within the print media tray. In this way, it can be advantageous to ensure that a flag sensor for determining the quantity of print media is not altered by the mechanisms for determining the size of the print media. It can be beneficial to ensure that the size adjustment mechanism does not interfere with the operation of the flag or other sensor for determining the quantity of print media within the print media tray. Interference with the flag or sensor for determining the quantity of print media can result in the printing device generating notifications or altering functions in response to the interference.

The present disclosure relates to media trays that include flags that are connected to moveable indicators. The flag is positioned within the media tray to interact with a surface of the print media within the print media tray. A size adjustment mechanism is positioned within the media tray to interact with an edge of the print media. The size adjustment mechanism can be set to ensure the print media is interacting with the flag. In some examples, the flag can include a curved surface and/or a tapered edge to allow the print media to move past the flag and engage the flag without causing a jam when the size adjustment mechanism moves the print media toward the flag.

The flag can be coupled to a transfer device that transfers the movement caused by a force from the print media on the flag to linear motion of a moveable indicator. The moveable indicator moves along a surface of a scanner device (e.g., scanner surface, etc.) in response to the movement of the flag. In these examples, the scanner device can include a scanner surface of a flatbed scanner device. The scanner device can include an imaging device to capture an image of the moveable indicator. The position of the moveable indicator corresponds to a movement of the flag caused by a force of the print media. The quantity of the movement of the flag corresponds to the quantity of print media within the print media tray. Thus, the location of the moveable indicator on the scanner surface will correspond to a quantity of print media that is applying force on the flag. In this way, the present disclosure provides a print media tray that allows a size adjustment mechanism to work with a flag and sensor to determine the quantity of print media within the print media tray.

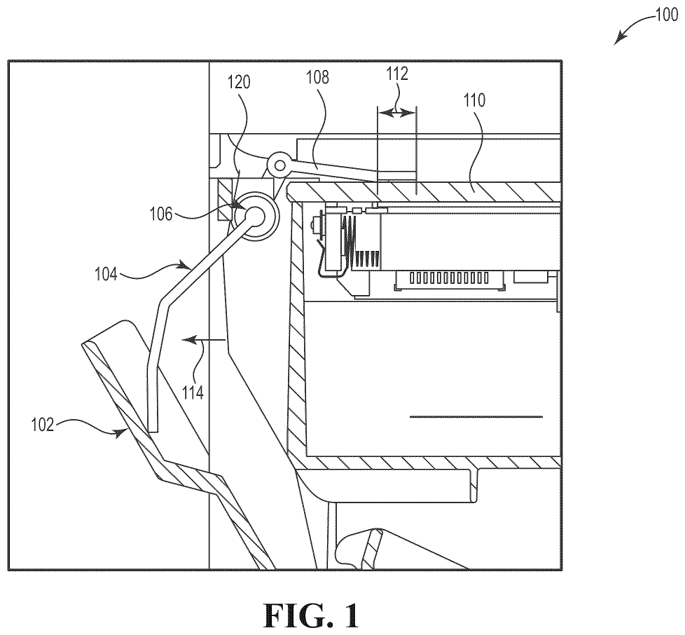

FIG. 1 illustrates an example device 100 that utilizes a flag 104 with a moveable indicator 108. The device 100 can include a portion of a printing device. As described herein, a printing device is a device utilized to generate images on a substrate or print media utilizing a print substance. For example, the printing device can be an inkjet printer that deposits ink at particular locations on a substrate to generate an image on the substrate. The device 100 includes a print media tray 102 (e.g., substrate tray, media tray, etc.) that can be utilized to store print media to be utilized by the printing device.

The print media tray 102 can allow a pick roller or pick mechanism of the printing device to extract the print media from the print media tray 102. For example, the print media within the print media tray 102 can be positioned with an edge of the print media that is accessible to a pick mechanism of the printing device. In this example, the pick mechanism extracts a piece or sheet of print media from the print media tray 102 and provides the print media to a print zone to deposit the print substance on the print media to generate an image on the print media.

The printing device may generate notifications and/or alter printing functions (e.g., stop print job, extract media from a different media tray, etc.) based on an estimation of a quantity of print media within the print media tray 102. Flag 104 may be arranged to interact with print media positioned within the print media tray 102. For example, the flag 104 is positioned within the print media tray 102 to receive a force from the print media when a surface of the print media makes contact with the surface of the flag 104.

A flag 104 includes a physical structure that is positioned at a location to receive a force from print media when a surface of the print media makes contact with the flag 104. For example, the flag 104 is a physical device made of a particular material (e.g., plastic, metal, etc.) to allow a surface of the print media to apply a force on the flag 104 when the print media is positioned within the print media tray 102. In these examples, the force of the print media on the flag 104 is transferred to a force on the transfer mechanism 106.

FIG. 1 illustrates an empty print media tray 102. The flag 104 is coupled to a biasing mechanism 120 (e.g., spring mechanism, etc.) to provide a force on the flag 104 in the direction of arrow 114. The flag 104 is forced by the biasing mechanism 120 in the direction of arrow 114 to make contact with an interior surface of the print media tray 102 when the print media tray 102 is empty. Further, when print media is positioned within the print media tray 102, the print media can be positioned between the interior surface of the print media tray 102 and the flag 104 to provide a force on the flag 104 in the direction that is opposite to the arrow 114.

The flag 104 is coupled to a transfer device 106 to transfer the movement of the flag 104 in the direction of arrow 114 to a motion of a moveable indicator 108 in a direction opposite of arrow 114. The motion of the flag 104 translates to a rotational movement about an axis (e.g., into and out of the print media tray 102 of FIG. 1) of the transfer device 106 against the force of the biasing mechanism 120. Movement of the transfer device 106 engenders the motion of the moveable indicator 108 across a scanner surface 110. Movement of the moveable indicator 108 may thus be in a linear movement or a horizontal movement relative to the scanner surface 110. A scanner surface 110 includes a surface of a scanner device. A scanner device can include an imaging device that captures or scans an image of an object. For example, the scanner surface 110 can include a scanner glass surface of a flatbed scanner of a scanner device to allow the scanner device to capture images of objects positioned on the scanner surface 110. The flatbed scanner or scanner surface 110 is positioned on a top surface of the printing device to allow access to the flatbed scanner when a cover of the flatbed scanner is moved.

A scanner system can include an image capture device to capture images of objects positioned on the scanner surface 110. The scanner system can capture an image of the moveable indicator 108 on the scanner surface. The image of the moveable indicator 108 or scanned image of the moveable indicator 108 is utilized to determine a location of the moveable indicator 108. The location of the moveable indicator 108 is based on a distance 112 that the moveable indicator 108 is in contact with the scanner surface 110. The distance 112 of the moveable indicator 108 corresponds to the quantity of print media within the print media tray 102. For example, the movement of the flag 104 in the direction of arrow 114 leads to movement of the moveable indicator 108 across the scanner surface 110 in a direction opposite of arrow 114. In contrast, movement of the flag 104 in a direction opposite the flag 114 leads to movement of the moveable indicator 108 across the scanner surface 110 in the direction of arrow 114. Consequently, depending on a stack height of media within the print media tray 102, more or less of the moveable indicator 108 may be visible to the scanner of the scanner surface 110. In this way, the distance 112 can be determined from the captured image of the moveable indicator 108 and a corresponding quantity of print media can be determined based on the distance 112.

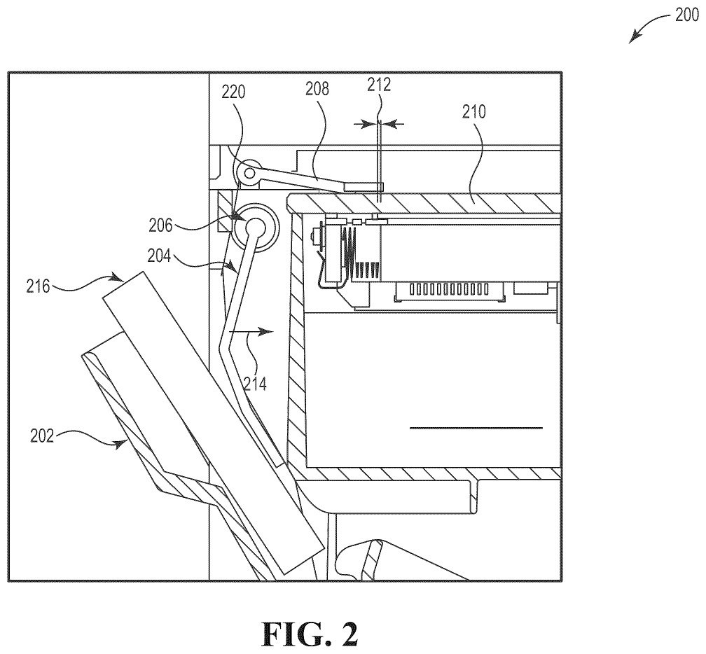

FIG. 2 illustrates an example device 200 that utilizes a flag 204 with a moveable indicator 208. The device 200 can be the same or similar device as device 100 as illustrated in FIG. 1. For example, the device 200 can include a flag 204 positioned within the print media tray 202 to receive a force from a surface of print media 216. As described herein, the print media 216 can be positioned within the print media tray 202 to make contact with the flag 204 and provide a force to move the flag 204 in the direction of arrow 214 or away from a surface of the print media tray 202.

The quantity of print media 216 that interacts with the flag 204 can correspond to a distance the flag 204 travels in the direction of arrow 214. In addition, the flag 204 can be coupled to a transfer device 206 that moves the moveable indicator 208 a corresponding distance in the direction opposite to arrow 214. The flag 204 is coupled to a biasing mechanism 220 to ensure that a surface of the flag 204 is in contact with the print media 216 and/or an interior surface of the print media tray 202 when the print media tray 202 is empty. In this way, a thickness of the print media 216 or stack of print media 216 can directly affect a distance 212 of contact of the moveable indicator 208 on a scanner surface 210. As described herein, the distance 212 can be utilized to determine a quantity of print media 216 within the print media tray 202.

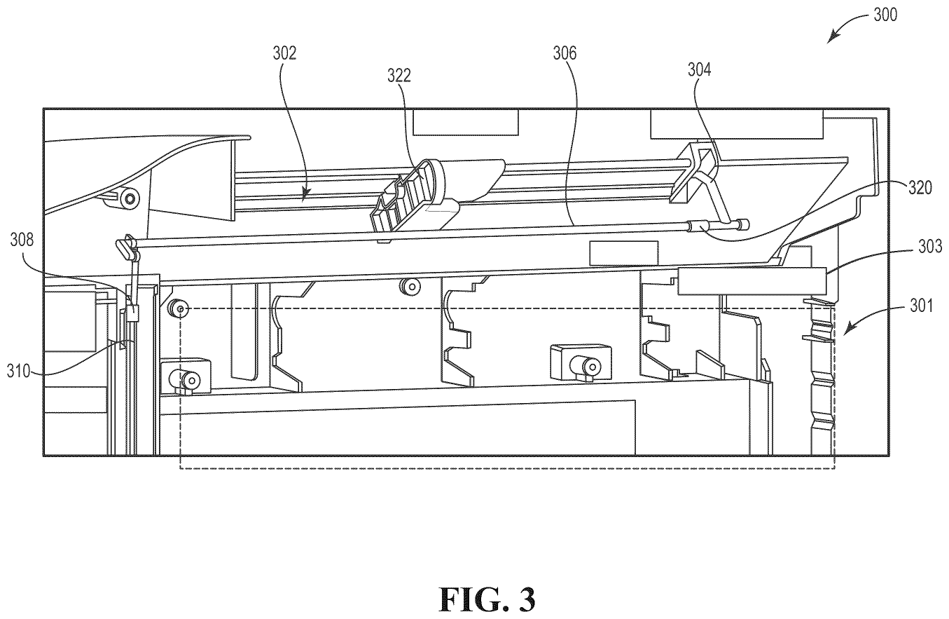

FIG. 3 illustrates a top-down perspective view of an example device 300 that utilizes a flag 304 with a moveable indicator 308 and a size adjustor mechanism 322. The view illustrated in FIG. 3 omits a top portion of a printing device housing in order to illustrate the linkage mechanism that translates movement of flag 304 to movement of moveable indicator 308. The device 300 includes the same or similar elements as device 200 as referenced in FIG. 2 and/or device 100 as referenced in FIG. 1.

The device 300 can be a printing device that includes a media tray 302. The media tray 302 receives print media between a first edge (e.g., left edge) and a second edge (e.g., right edge) to allow a leading edge of the print media to interact with a pick roller. A leading edge of the print media is an edge of the print media that enters a print zone or print path first. The media tray 302 can include a size adjustor mechanism 322 (e.g., media width adjustor, etc.) positioned on a first edge of the media tray 302 (e.g., illustrated on the left edge of the media tray 302 in FIG. 3), and a media flag 304 positioned on a second edge of the media tray 302 (e.g., illustrated on the right edge of the media tray 302 in FIG. 3).

The media flag 304 can include a first side that has a convex shape and a second side that has a corresponding concave shape. The first side is arranged to interact with print media or receive a force from the print media positioned within the media tray 302. That is, the surface of the print media provides a force on the concave side of the flag 304 to move the flag in the direction of the convex side. In these examples, the device 300 includes a scanner surface 310. The scanner surface 310 is part of a scanner device 303 to capture images of the moveable indicator 308 on the scanner surface 310. The captured images of the moveable indicator 308 can be used to identify a current location of a moveable indicator 308. Identifying the current location or position of the moveable indicator 308 is done utilizing the captured images from the scanner device 303. For example, the scanner device 303 moves to the scanner surface 310 to determine the location of the moveable indicator 308 on the scanner surface 310 at a particular time.

As described herein, the moveable indicator 308 moves relative to the movement of the media flag 304. For example, the force of the print media interacting with the media flag 304 moves the media flag 304 a particular distance that is transferred to a corresponding movement of the moveable indicator 308. The moveable indicator 308 can be at a home position of a scanner (e.g., parking position, starting position, scanner home position, etc.). A scanner home position is usually outside of scan window 301 (e.g., area utilized to scan documents, etc.).

A portion of the scan window 301 is illustrated in FIG. 3 by a dashed line. The scan window 301 can be used as a surface to position documents to be scanned by a scanner device 303. The scanner device 303 will move into a scanning position within the scan window 301 in response to signals from a controller or computing device to perform an image scan of a document. The moveable indicator 308 can have more freedom of movement without interacting or interfering with a scan of a document by aligning the moveable indicator 308 within the scanner home position instead of positioning the moveable indicator 308 within the scan window 301. However, it may nevertheless be possible to use the moveable indicator 308 within the scan window 301 of the scanner surface 310. In such cases, the moveable indicator 308 may be relatively smaller or be positioned to not affect the scan window 301 of the scanner surface 310.

The device 300 includes a size adjustor mechanism 322 (e.g., width adjustor mechanism, media size adjustor, etc.). The size adjustor mechanism 322 is positioned on a first edge of the print media tray 302 and the flag 304 is positioned on a second edge of the print media tray 302. In this way, the size adjustor mechanism 322 interacts with a first edge of the print media and the flag 304 is able to interact with a surface closer to the second edge of the print media. For example, the size adjustor mechanism 322 can interact with or adjust a position of the print media through the interaction with the first edge of the print media. In this example, the size adjustor mechanism 322 can ensure that a surface of the print media is interacting with a surface of the flag 304. The second edge of the print media interacts with an edge of the flag 304 and the tapered edge of the flag 304 and convex shape of the flag 304 direct the print media toward the convex side of the flag 304. The surface of the print media is then positioned to provide a force on the convex side of the flag 304 to move the flag 304 in the direction of the concave side of the flag 304.

The size adjustor mechanism 322 can move the print media within the print media tray 302 toward the flag 304 when the print media is inserted into the print media tray 302 prior to the media width adjustor (e.g., size adjustor mechanism 322, etc.) being set to the size of the print media. For example, the print media may be inserted into the print media tray 302 such that the print media does not make contact with the flag 304. In these examples, there may be no detection of print media when the print media is positioned between the size adjustor mechanism 322 and the flag 304 and not making contact with the flag 304.

The media width adjustor 332 can be moved toward the flag 304 to force the print media to interact with an edge of the flag 304. The edge of the flag 304 is tapered to force the print media to the convex side of the flag 304 to provide a force on the flag 304 in the direction of the concave side of the flag 304. The media width adjustor 332 can be utilized to ensure that the print media is interacting with the flag 304 or providing a force on the concave side of the flag 304. In this way, the media width adjustor 332 can ensure that the print media is being detected by the flag 304 and/or moveable indicator 308.

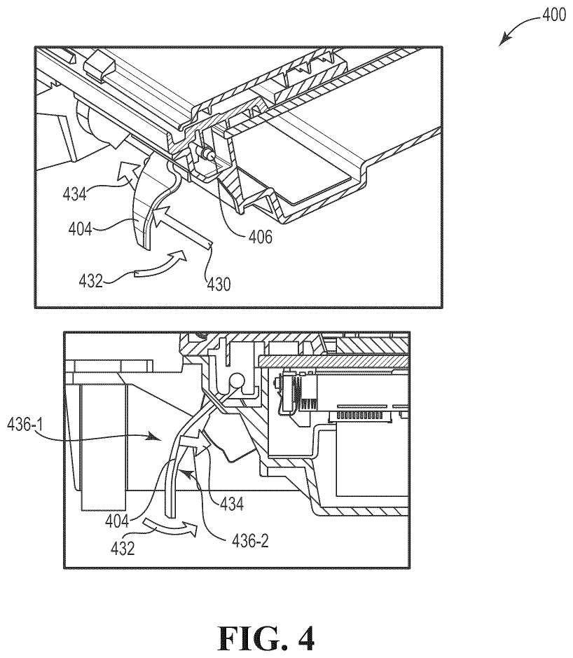

FIG. 4 illustrates an example device 400 that utilizes a flag 404 with a convex side 436-1 and a concave side 436-2. The device 400 includes the same or similar elements as device 300 as referenced in FIG. 3, device 200 as referenced in FIG. 2, and/or device 100 as referenced in FIG. 1. For example, the device 400 includes a flag 404 that is coupled to a transfer device 406. The flag 404 includes a convex side 436-1 that interacts with print media within the print media tray. In this way, the print media can make contact with the flag 404 and force the rotational movement of the flag 404 that is transferred by the transfer device 406 to move a moveable sensor. The movement of the moveable sensor can indicate a quantity of print media within the print media tray.

A convex side 436-1 includes a convex shaped surface or curved surface. For example, the convex side 436-1 includes a rounded surface that includes a tapered edge to a particular point on a first side of the flag 404. In some examples, the convex side 436-1 is a surface of the flag 404 that interacts with a surface of the print media within the print media tray. The convex side 436-1 allows the print media to interact with an edge of the flag 404 and still provide the force on the flag 404 to rotate the transfer device 406. As described herein, the print media can be moved by a media width adjustor to interact with an edge of the flag 404. The convex side 436-1 allows the media to move from an edge of the flag 404 to the convex side 436-1 without causing a jam between the flag 404 and the media width adjustor.

The concave side 436-2 can be a side of the flag 404 opposite to the convex side 436-1. For example, the convex side 436-1 can be a first side of the flag 404 and the concave side 436-2 can be a second side of the flag 404. In some examples, the concave side 436-2 can be a curved side of the flag 404 that curves inward to a point of the flag 404. In some examples, the curved point of the concave side 436-2 can correspond to the curved point of the convex side 436-1.

The convex side 436-1 provides a surface to interact with or receive a force from the print media such that the force from the print media will move the flag 404 even when the print media is forced towards the flag 404 from a side of the flag 404. The flag 404 includes a convex side 436-1 with a convex tapered edge and the concave side 436-2 with a concave tapered edge. In some examples, the force of the print media interacting with an edge of the flag 404 is illustrated by arrow 430. Since the print media is interacting with the convex side 436-1, the force of the print media illustrated by arrow 430 is transferred to a force illustrated by arrow 434. The force in the direction of arrow 434 can move the flag 404 in the direction of arrow 432. In this way, the curved surface of the convex side 436-1 is able to transfer the force of the print media into the motion illustrated by arrow 432 of the flag 404. In this way, the convex side 436-1 of the flag 404 prevents the print media from jamming or bypassing the flag 404 when the print media is moved toward an edge of the flag 404. Thus, a print media width adjustor is able to move the print media toward the flag 404 when the print media is within the print media tray without risking a jam between the edge of the flag 404 and the print media.

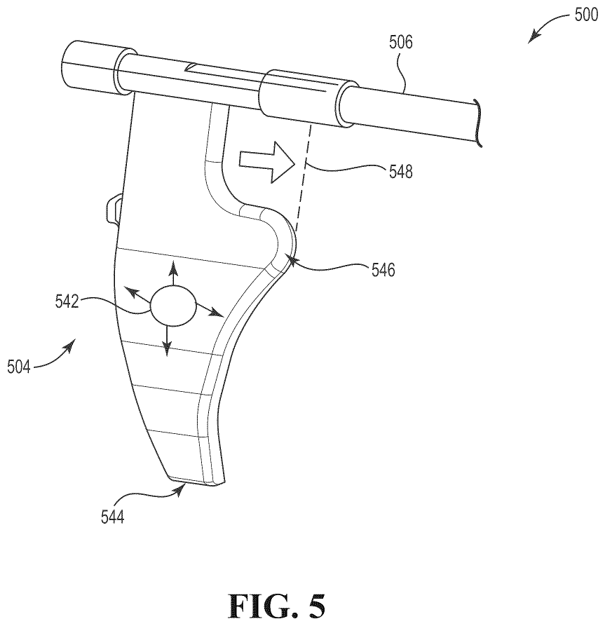

FIG. 5 illustrates an example device 500 that utilizes a flag 504 with a convex side and a concave side. In some examples, the device 500 can illustrate a flag 504 that includes a convex side that interacts with print media. The flag 504 is coupled to a transfer device 506 that can transfer the motion of the flag 504 to a corresponding motion of a moveable indicator. The flag 504 can be positioned within a print media tray to interact with a surface of print media within the print media tray.

The flag 504 can be coupled to a biasing mechanism (e.g., spring, etc.) to maintain contact with a surface of the print media such that a distance moved by the flag 504 translates into a corresponding linear movement of the moveable indicator. In this way, the linear movement of the moveable indicator can be utilized to determine the quantity of print media within the print media tray. The convex side of the flag 504 can receive a force from print media to move the flag 504 in a direction of the concave side. As described herein, the convex side allows print media to generate motion of the flag 504 while the print media is moved in a parallel direction of the flag 504 or moved toward an edge of the flag 504. In a similar way, the convex side allows print media to generate a rotational motion of the flag 504 or transfer device 506 while the print media is moved in an axial direction of the flag 504.

The convex side of the flag 504 includes a point 542. The flag 504 can be rounded or raised from the edges of the flag 504 to the point 542. For example, the point 542 can be a raised point that is tapered to lower points toward the edges of the flag 504 in a plurality of directions moving away from the point 542. In some examples, the convex side of the flag 504 can be a domed or spherical shape. For example, the flag 504 can be shaped as if it were a portion of a surface of a sphere. In this way, the point 542 may be a relative high point of the surface of the flag 504 and the edges of the flag 504 may be relative low points of the surface of the flag 504.

The width of the flag 504 can be different along the length of the flag 504. For example, the width of the flag 504 can be a first distance at a tip 544 and a second distance at a location 546 between the tip 544 and a coupling location between the flag 504 and the transfer device 506. The tip 544 can be a location on the flag 504 that is opposite to the coupling location between the flag 504 and the transfer device 506. The tip 544 can be a relatively shorter width compared to the width of the flag at the coupling location between the flag 504 and the transfer device 506.

The flag 504 includes an increasing size from a tip 544 of the flag 504 toward a connection point with the transfer device 506. The increasing size includes an increasing distance between edges of a first side and a second side of the flag 504. In some examples, the width of the flag 504 can increase in size or distance from the tip 544 to the location 546 and/or to a coupling location between the flag 504 and the transfer device 506. For example, the tip 544 may have the shortest width and the location 546 may have the largest width. In some examples, the width at the coupling location between the flag 504 and the transfer device 506 may have a portion of the width that is removed. However, in other examples, the flag 504 may be extended to or extended beyond the line 548. In these examples, the width of the flag 504 can be increased from a first width at the tip 544 to a second width at the coupling location between the transfer device 506 and the flag 504. In these examples, the first width is shorter than the second width. In these examples, the first width can be the shortest width of the flag 504 and the second width can be the longest width of the flag 504.

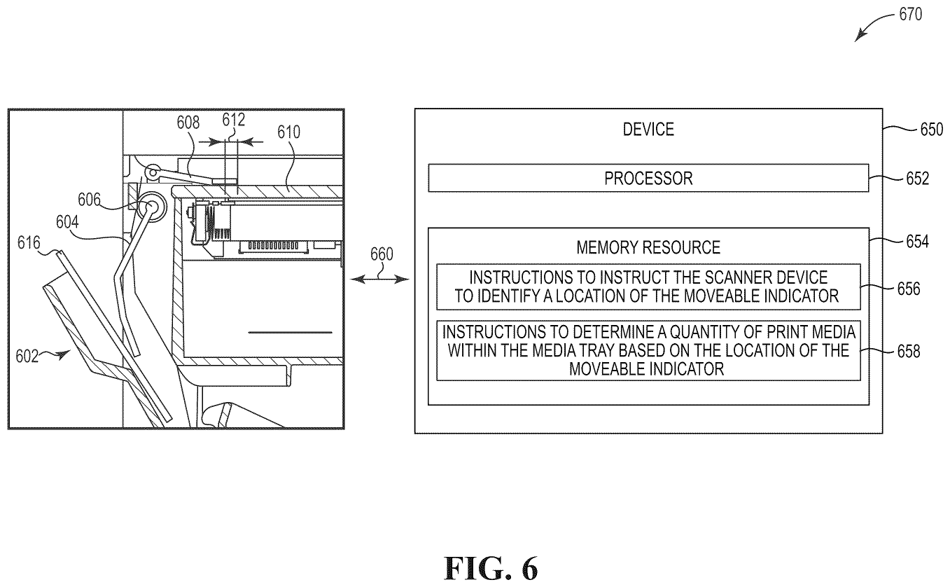

FIG. 6 illustrates an example system 670 that utilizes a flag 604 with a moveable indicator 608. In some examples, the system 670 can include a device 650 that is communicatively coupled to a printing device through a communication path 660. The communication path 660 can be a wired or wireless communication path that is utilized to transfer electronic signals and/or data signals. The communication path 660 can be utilized to receive a scan of the moveable indicator 608. The moveable indicator 608 is a scannable device that moves along the scanner surface 610 in response to movement of the flag 604.

The system 670 includes a print media tray 602 that includes a flag 604. As described herein, the flag 604 interacts with a surface of print media 616 positioned within the print media tray 602. The motion of the flag 604 caused by a thickness of the print media 616 can be transferred by a transfer device 606 to a moveable indicator 608. The thickness or quantity of print media 616 corresponds to a particular movement of the flag 604 and a corresponding distance 612 of interaction of the moveable indicator 608 on the surface of the scanner surface 610. In some examples, the captured scan or determined distance from the captured scan can be sent to the device 650 through the communication path 660.

In some examples, the device 650 can be a computing device that includes a processor 652 communicatively coupled to a memory resource 654 through a communication path. The processor 652 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 656, 658. In other examples, the computing device can include instructions 656, 658, stored on a machine-readable medium (e.g., memory resource 654, non-transitory computer-readable medium, etc.) and executable by a processor 652. In a specific example, the computing device utilizes a non-transitory computer-readable medium storing instructions 656, 658, that, when executed, cause the processor 652 to perform corresponding functions.

The memory resource 654 may be electronic, magnetic, optical, or other physical storage device that stores executable instructions. Thus, a non-transitory machine-readable medium (MRM) (e.g., a memory resource 654) may be, for example, a non-transitory MRM comprising Random-Access Memory (RAM), read-only memory (ROM), an Electrically Erasable Programmable ROM (EEPROM), a storage drive, an optical disc, and the like. The non-transitory machine-readable medium (e.g., a memory resource 654) may be disposed within a controller and/or computing device. In this example, the executable instructions 656, 658, can be “installed” on the device. Additionally, and/or alternatively, the non-transitory machine-readable medium (e.g., a memory resource) can be a portable, external, or remote storage medium, for example, that allows a computing system to download the instructions 656, 658, from the portable/external/remote storage medium. In this situation, the executable instructions may be part of an “installation package”.

The memory resource 654 includes instructions 656 that can be executed by the processor 652 to instruct the scanner device to scan an image of a location of the moveable indicator 608 on the scan surface 610. The device 650 can send a signal to the scanner device to initiate a scan. The moveable indicator 608 can be positioned on a scan surface 610 of the scanner device at a particular location based on the print media 616 interacting with the flag 604. In this way, the device 650 can receive the scan data of the moveable indicator 608 to determine a location and/or distance 612 of the moveable indicator 608.

The memory resource 654 includes instructions 658 that can be executed by the processor 652 to determine a quantity of print media 616 within the media tray 602 based on the location of the moveable indicator 608. The location of the moveable indicator 608 corresponds to a distance between a first location and a second location on the scanner surface 610. In these examples, the first location is a position of the moveable indicator 608 when the media tray 602 is empty and the second location is a position of the moveable indicator 608 when the media tray 602 is full of print media 616.

As described herein, the distance 612 of the moveable indicator 608 is a surface distance of the moveable indicator 608 that is in contact with the scanner surface 610. The distance 612 can correspond to the quantity of print media 616 within the print media tray 602. In these examples, the current location of the moveable indicator 608 corresponds to a quantity of print media 616 interacting with the flag 604.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A device, comprising:
a flag;
a transfer device to transfer rotational motion of the flag to linear motion of a moveable indicator; and
a scanner device to capture an image of a current location of the moveable indicator on a scanner surface.

2. The device of claim 1, wherein the current location of the moveable indicator corresponds to a quantity of print media interacting with the flag.

3. The device of claim 1, wherein the flag includes a first side that is a convex shape and a second side that is a concave shape and wherein the first side is arranged to interact with print media to move the flag in a direction of the second side.

4. The device of claim 3, wherein the first side includes a raised point that is tapered to lower points toward the edges of the flag in a plurality of directions from the raised point.

5. The device of claim 1, wherein the flag includes an increasing size from a tip of the flag toward a connection point with the transfer device.

6. The device of claim 5, wherein the increasing size includes an increasing distance between edges of the flag.

7. The device of claim 1, wherein the moveable indicator is a scannable device arranged to move along the scanner surface of the scanner device in response to movement of the flag.

8. A printing device, comprising:
a media tray to receive print media;
a media width adjustor positioned on a first edge of the media tray;
a media flag positioned on a second edge of the media tray, wherein the media flag includes a first side that is a convex shape to interact with print media positioned within the media tray and a second side that is a concave shape; and
a scanner device to scan an image of a current location of a moveable indicator that moves along a scanner surface of the scanner device in response to movement of the media flag from interacting with print media positioned within the media tray.

9. The printing device of claim 8, wherein the first side of the media flag is arranged to receive a force from print media while the print media is moved from the first edge of the media tray to the second edge of the media tray.

10. The printing device of claim 9, wherein the print media moves the media flag in a direction of the second side of the media flag.

11. The printing device of claim 8, wherein the media flag includes a first width at a first portion of the media flag and a second width at a second portion of the media flag.

12. A system, comprising:
a media tray to receive print media;
a scanner device with a scan surface to capture images of objects on the scan surface;
a moveable indicator positioned on the scan surface;
a media flag within the media tray to move the moveable indicator along the scan surface in response to a force received while interacting with print media within the media tray, wherein the media flag includes a convex side to interact with the print media; and
a processor to:
instruct the scanner device to scan an image of a location of the moveable indicator on the scan surface; and
determine a quantity of print media within the media tray based on the location of the moveable indicator on the scan surface.

13. The system of claim 12, wherein rotational motion of the media flag is transferred to linear motion of the moveable indicator.

14. The system of claim 12, wherein the location of the moveable indicator corresponds to a distance between a first location and a second location on the scan surface.

15. The system of claim 14, wherein the first location is a position of the moveable indicator while the media tray is empty and the second location is a position of the moveable indicator while the media tray is full of print media.
